(19) United States
(12) Patent Application Publication
(10) Pub. No.: US 2006/0087834 A1
(43) Pub. Date: Apr. 27, 2006

(54) Directional lighting system

(76) Inventors: Christina Marie Houts, Traverse City, MI (US); Rex Adam Crouch, Traverse City, MI (US)

Correspondence Address: Houts and Crouch, 880 Pine Grove Ave, Traverse City, MI, 49686, US

(21) Appl. No.: 10/969,611

(22) Filed: Oct. 21, 2004

(51) Int. Cl. F21S 8/00

(52) U.S. Cl. 362/145

(57) ABSTRACT

The Directional Lighting System employees a hollow pole capped with a reflective bowl shaped device and encased by a lens. The lamp (light source) is contained in the based of the pole allowing easy access for replacement and maintenance. The light shines up through the pole, striking the interior reflective surface of the pole and bowl shaped reflective device and then is projected to the ground. Light is not emitted up or out into the sky thus reducing light pollution or wasted light while providing easy access to replace defective lamps. This method significantly reduces light pollution and subsequently reduces energy waste and cost associated with light pollution while providing a more effective means of maintaining the lighting system.

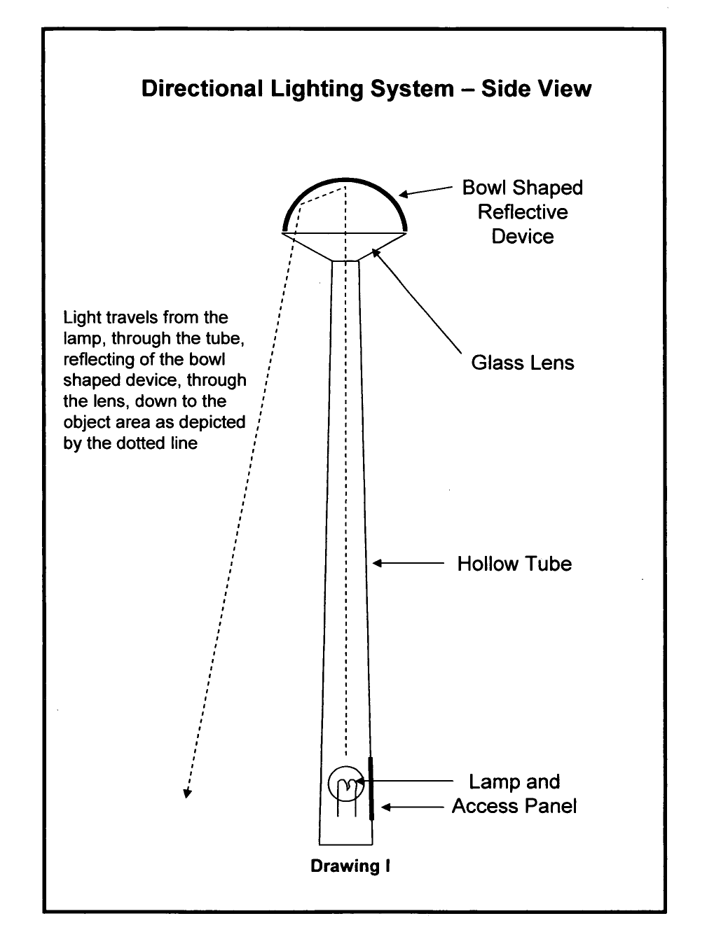

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The Directional Lighting System is of Class 362 (Illumination: Reflector Sub-Class 514 reflectors—wherein the adjustable means is a bowl-shaped device usually made of a polished metal or plastic for redirecting light back into a medium of which the general class subject matter provides for a method of shining a lamp from the ground, up through a tube, to a reflective bowl shaped device, and redirecting the light down through a lens and to the object area on the ground reducing light radiating up and thus reducing light pollution. The residual class for subject matter relates to directing light to specific object areas on the ground for the specific purpose of reducing light pollution.

### BRIEF SUMMARY OF THE INVENTION

The Directional Lighting System places a lamp inside and at the base of a hollow tube affixed to the ground or set perpendicular to the surface. The lamp shines up the tube to the reflective bowl shaped device and reflects down through a lens to the ground. The light is directed toward the ground and reduces light pollution, while the light assembly is located near ground level in the tube with an access panel allowing for easy replacement of lamps.

### BRIEF DESCRIPTION OF THE SEVERAL VIEWS OF THE DRAWINGS

Drawing I is a Directional Lighting System. The drawing shows the hollow tube, the lamp inside the base of the tube, the bowl shaped reflective device at the top, and the attached lens.

### DETAILED DESCRIPTION OF THE INVENTION

The Directional Lighting System places a lamp socket and mount with lamp inside the base of a hollow tube. The tube is affixed to the ground or set perpendicular to the horizontal. The tube has an access panel for easy access to the lamp. The lamp is directed upwards. The lamps shines up the tube to the reflective bowl shaped device at the top. The curvature of the bowl shaped device can be adjusted during fabrication to accommodate a determined range of reflection desired with parabolic in shape used to reflect the light directly back down. The light is reflected down through a lens to the ground or object area. Directing the light toward the ground reduces-light pollution while the light itself is located near ground level allowing for easy maintenance of lamps.

1. What we claim as our invention, the directional lighting system, is a system that provides a method of illumination for flagpoles, streetlights, commercial lighting, non-commercial lighting, and residential outdoors lighting that allows easy access to replace the lamp while reducing light pollution by directing light down to the object area.
